(19) United States
(12) Patent Application Publication
(10) Pub. No.: US 2022/0413324 A1
(43) Pub. Date: Dec. 29, 2022

(54) COMPACT IMAGING OPTICS USING LIQUID CRYSTAL (LC) FOR DYNAMIC GLARE REDUCTION AND SHARPNESS ENHANCEMENT

(71) Applicant: Meta Platforms Technologies, LLC, Menlo Park, CA (US)

(72) Inventors: Zheng Sun, San Jose, CA (US); Wanyue Song, Santa Clara, CA (US); Youngshik Yoon, Cupertino, CA (US); Woong Hwang, Ansan-Si (KR)

(73) Assignee: Meta Platforms Technologies, LLC, Menlo Park, CA (US)

(21) Appl. No.: 17/362,411

(22) Filed: Jun. 29, 2021

(51) Int. Cl. G02F 1/01; G02F 1/137

(52) U.S. Cl. CPC G02F 1/0136; G02F 1/137; G02B 27/0172

(57) ABSTRACT

An optical assembly to reduce glare and enhance sharpness in a head-mounted device (HMD) is provided. The optical assembly may include an optical stack, such as pancake optics. The optical assembly may also include at least two optical elements. The optical assembly may further include at least one liquid crystal (LC) layer between the at least two optical elements, wherein the liquid crystal (LC) layer provides dynamic glare reduction and enhanced sharpness using a controllable polarization technique. In some examples, the controllable polarization technique may include determining optical assembly orientation using a sensor. Based the optical assembly orientation, the polarization of the at least one liquid crystal (LC) layer may be dynamically adjusted via adjustments in applied voltage to minimize or reduce glare and enhance visual sharpness.

### TECHNICAL FIELD

This patent application relates generally to optical lens design and configurations in optical systems, such as head-mounted displays (HMDs), and more specifically, to systems and methods for dynamic glare reduction and sharpness enhancement using compact imaging optics with a liquid crystal (LC) layer in a head-mounted display (HMD) or other optical device.

### BACKGROUND

Optical lens design and configurations are part of many modem-day devices, such as cameras used in mobile phones and various optical devices. One such optical device that relies on optical lens design is a head-mounted display (HMD). In some examples, a head-mounted display (HMD) may be a headset or eyewear used for video playback, gaming, or sports, and in a variety of contexts and applications, such as virtual reality (VR), augmented reality (AR), or mixed reality (MR).

Some head-mounted displays (HMDs) rely on lens designs or configurations that are lighter and less bulky. For instance, pancake optics are commonly used to provide a thinner profile in certain head-mounted displays (HMDs). However, conventional pancake optics may not provide an effective anti-glare or enhanced sharpness feature without additional dedicated optical components, which often increase weight, size, cost, and inefficiency.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a system associated with a head-mounted display (HMD), according to an example.

FIGS. 2A-2B illustrate various head-mounted displays (HMDs), in accordance with an example.

FIGS. 3A-3C illustrate schematic diagrams of various optical assemblies for dynamic glare reduction and/or sharpness enhancement, according to an example.

FIGS. 4A-4D illustrate a liquid crystal (LC) layer for dynamic glare reduction and/or sharpness enhancement, according to an example.

FIG. 5 illustrates a flow chart of a method for dynamic glare reduction and/or sharpness enhancement using compact imaging optics, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

There are many types of optical devices that utilize optical design configurations. For example, a head-mounted display (HMD) is an optical device that may communicate information to or from a user who is wearing the headset. For example, a virtual reality (VR) headset may be used to present visual information to simulate any number of virtual environments when worn by a user. That same virtual reality (VR) headset may also receive information from the users eye movements, head/body shifts, voice, or other user-provided signals.

In many cases, optical lens design configurations seek to decrease headset size, weight, cost, and overall bulkiness. However, these attempts to provide a cost-effective device with a small form factor often limits the function of the head-mounted display (HMD). For example, while attempts to reduce the size and bulkiness of various optical configurations in conventional headsets can be achieved, this often reduces the amount of space needed for other built-in features of a headset, thereby restricting or limiting a headset's ability to function at full capacity.

Pancake optics may be used to provide a thin profile or a lightweight design for head-mounted displays (HMDs) and other optical systems. However, conventional pancake optics, in attempting to provide a smaller form factor and thinner profile, often fail in providing other important features. For instance, conventional pancake optics design can typically provide glare prevention or sharpness enhancement only by using additional optical components. Furthermore, conventional pancake optics can provide an auto-focusing (AF) feature, but may do so only with high power consumption and increased mechanical movement, both of which may adversely affect cost, size, temperature, and/or other performance issues.

The systems and methods described herein may provide dynamic glare reduction and/or sharpness enhancement using compact imaging optics. Rather than using additional dedicated optical components, a liquid crystal (LC) layer or other similar material may be provided in an optical assembly of a head-mounted display (HMD) or other optical system. As described herein, the liquid crystal (LC) layer, for example, may be provided in one or more gaps between optical components of pancake optics so no significant or substantial increase in space is required. Furthermore, the use of a liquid crystal (LC) layer may provide a multitude of functions. For examples, the liquid crystal (LC) layer may function to as polarizer to reduce glare and/or enhance image sharpness, as described herein. An advantage of using a liquid crystal (LC) layer rather than a dedicated polarizer is that liquid crystal (LC) material, which when exhibiting mechanical radial movement, may provide dynamic polarization effects regardless of rotation angle or other movements. This cannot be achieved using a conventional static polarizer.

Moreover, a liquid crystal (LC) layer may also serve or function as any number of optical components within an optical stack. For example, for curved optical components or windows in pancake optics, the liquid crystal (LC) layer, which may be placed within these non-flat components, may also take on a “curved” shape. The resulting contours may cause the liquid crystal (LC) layer, either when voltage is applied or not, to function similarly like an optical lens or other optical element. In this way, use of one or more liquid crystal (LC) layers may minimize need for additional optics or currently existing optical components in pancake optics. In addition, customizable volumetric control of the liquid crystal (LC) layer may provide thermal compensation or other similar effects. In other words, by providing a liquid crystal (LC) layer that is customizable in size, thickness, etc., the systems and methods described herein may provide a flexible and low-cost way to improve visual acuity without increasing size, thickness, cost, or overall bulkiness of the optical assembly. These and other examples will be described in more detail herein.

It should also be appreciated that the systems and methods described herein may be particularly suited for virtual reality (VR), augmented reality (AR), and/or mixed reality (MR) environments, but may also be applicable to a host of other systems or environments that include optical lens assemblies, e.g., those using pancake optics or other similar optical configurations. These may include, for example, cameras or sensors, networking, telecommunications, holography, or other optical systems. Thus, the optical configurations described herein, may be used in any of these or other examples. These and other benefits will be apparent in the description provided herein.

System Overview

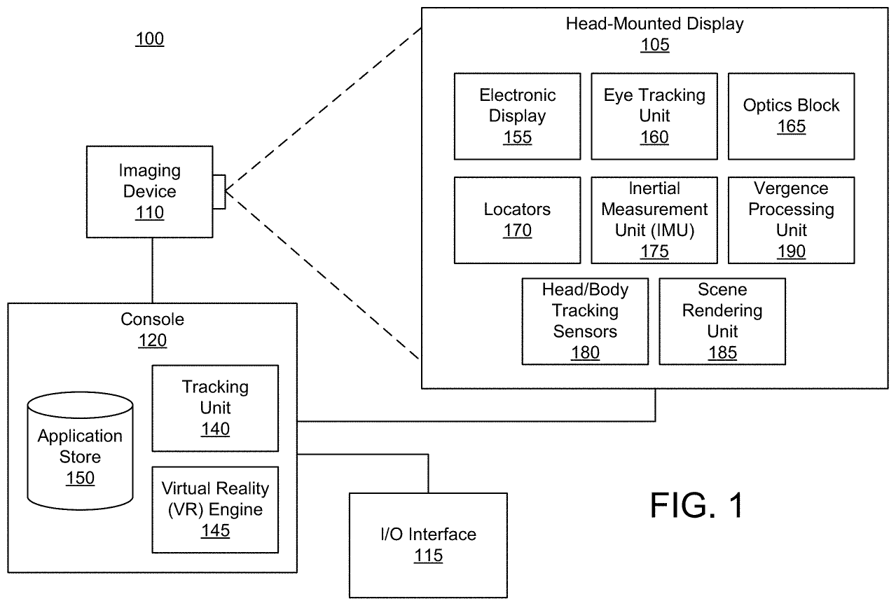

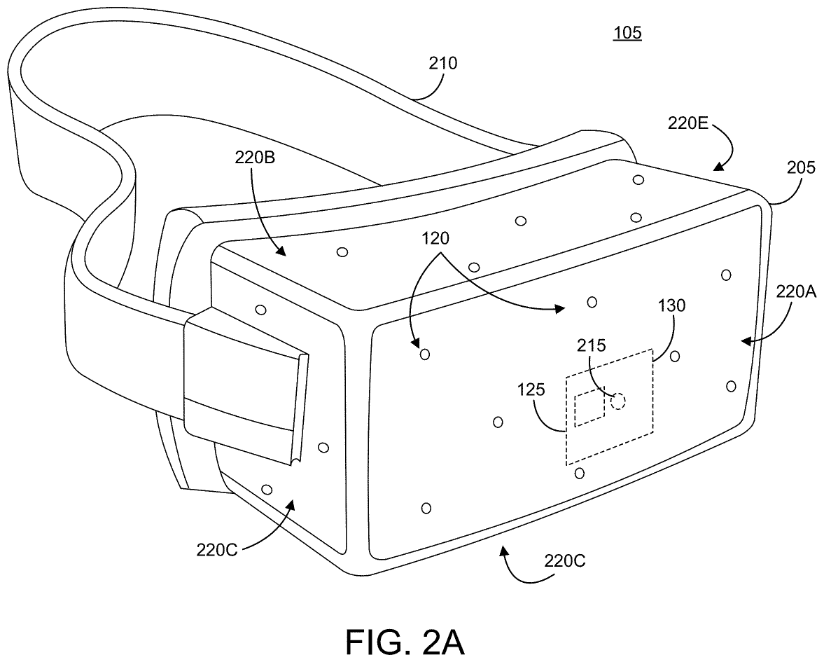

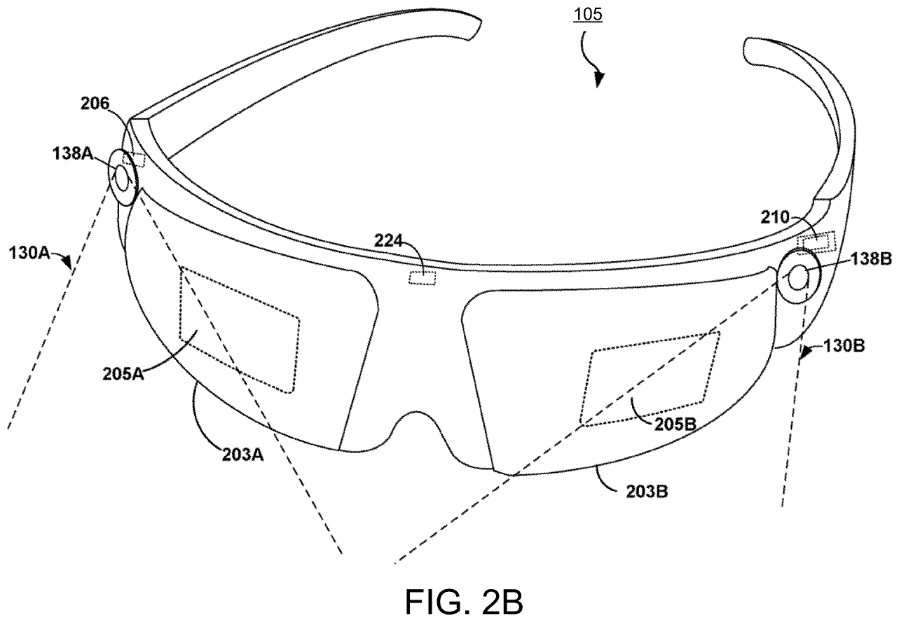

Reference is made to FIGS. 1 and 2A-2B. FIG. 1 illustrates a block diagram of a system 100 associated with a head-mounted display (HMD), according to an example. The system 100 may be used as a virtual reality (VR) system, an augmented reality (AR) system, a mixed reality (MR) system, or some combination thereof, or some other related system. It should be appreciated that the system 100 and the head-mounted display (HMD) 105 may be exemplary illustrations. Thus, the system 100 and/or the head-mounted display (HMD) 105 may or not include additional features and some of the features described herein may be removed and/or modified without departing from the scopes of the system 100 and/or the head-mounted display (HMD) 105 outlined herein.

In some examples, the system 100 may include the head-mounted display (HMD) 105, an imaging device 110, and an input/output (I/O) interface 115, each of which may be communicatively coupled to a console 120 or other similar device.

While FIG. 1 shows a single head-mounted display (HMD) 105, a single imaging device 110, and an I/O interface 115, it should be appreciated that any number of these components may be included in the system 100. For example, there may be multiple head-mounted displays (HMDs) 105, each having an associated input interface 115 and being monitored by one or more imaging devices 110, with each head-mounted display (HMD) 105, I/O interface 115, and imaging devices 110 communicating with the console 120. In alternative configurations, different and/or additional components may also be included in the system 100. As described herein, the head-mounted display (HMD) 105 may act be used as a virtual reality (VR), augmented reality (AR), and/or a mixed reality (MR) head-mounted display (HMD). A mixed reality (MR) and/or augmented reality (AR) head-mounted display (HMD), for instance, may augment views of a physical, real-world environment with computer-generated elements (e.g., images, video, sound, etc.).

The head-mounted display (HMD) 105 may communicate information to or from a user who is wearing the headset. In some examples, the head-mounted display (HMD) 105 may provide content to a user, which may include, but not limited to, images, video, audio, or some combination thereof. In some examples, audio content may be presented via a separate device (e.g., speakers and/or headphones) external to the head-mounted display (HMD) 105 that receives audio information from the head-mounted display (HMD) 105, the console 120, or both. In some examples, the head-mounted display (HMD) 105 may also receive information from a user. This information may include eye moments, head/body movements, voice (e.g., using an integrated or separate microphone device), or other user-provided content.

The head-mounted display (HMD) 105 may include any number of components, such as an electronic display 155, an eye tracking unit 160, an optics block 165, one or more locators 170, an inertial measurement unit (IMU) 175, one or head/body tracking sensors 180, and a scene rendering unit 185, and a vergence processing unit 190.

While the head-mounted display (HMD) 105 described in FIG. 1 is generally within a VR context as part of a VR system environment, the head-mounted display (HMD) 105 may also be part of other HMD systems such as, for example, an AR system environment. In examples that describe an AR system or MR system environment, the head-mounted display (HMD) 105 may augment views of a physical, real-world environment with computer-generated elements (e.g., images, video, sound, etc.).

An example of the head-mounted display (HMD) 105 is further described below in conjunction with FIG. 2. The head-mounted display (HMD) 105 may include one or more rigid bodies, which may be rigidly or non-rigidly coupled to each other together. A rigid coupling between rigid bodies causes the coupled rigid bodies to act as a single rigid entity. In contrast, a non-rigid coupling between rigid bodies allows the rigid bodies to move relative to each other.

The electronic display 155 may include a display device that presents visual data to a user. This visual data may be transmitted, for example, from the console 120. In some examples, electronic display 155 may also present tracking light for tracking the user's eye movements. It should be appreciated that the electronic display 155 may include any number of electronic display elements (e.g., a display for each of the user). Examples of a display device that may be used in the electronic display 155 may include, but not limited to a liquid crystal display (LCD), a light emitting diode (LED), an organic light emitting diode (OLED) display, an active-matrix organic light-emitting diode (AMOLED) display, micro light emitting diode (micro-LED) display, some other display, or some combination thereof.

The optics block 165 may adjust its focal length based on or in response to instructions received from the console 120 or other component. In some examples, the optics block 165 may include a multi multifocal block to adjust a focal length (adjusts optical power) of the optics block 165.

The eye tracking unit 160 may track an eye position and eye movement of a user of the head-mounted display (HMD) 105. A camera or other optical sensor inside the head-mounted display (HMD) 105 may capture image information of a user's eyes, and the eye tracking unit 160 may use the captured information to determine interpupillary distance, interocular distance, a three-dimensional (3D) position of each eye relative to the head-mounted display (HMD) 105 (e.g., for distortion adjustment purposes), including a magnitude of torsion and rotation (i.e., roll, pitch, and yaw) and gaze directions for each eye. The information for the position and orientation of the user's eyes may be used to determine the gaze point in a virtual scene presented by the head-mounted display (HMD) 105 where the user is looking.

The vergence processing unit 190 may determine a vergence depth of a user's gaze. In some examples, this may be based on the gaze point or an estimated intersection of the gaze lines determined by the eye tracking unit 160. Vergence is the simultaneous movement or rotation of both eyes in opposite directions to maintain single binocular vision, which is naturally and/or automatically performed by the human eye. Thus, a location where a user's eyes are verged may refer to where the user is looking and may also typically be the location where the users eyes are focused. For example, the vergence processing unit 190 may triangulate the gaze lines to estimate a distance or depth from the user associated with intersection of the gaze lines. The depth associated with intersection of the gaze lines can then be used as an approximation for the accommodation distance, which identifies a distance from the user where the users eyes are directed. Thus, the vergence distance allows determination of a location where the users eyes should be focused.

The one or more locators 170 may be one or more objects located in specific positions on the head-mounted display (HMD) 105 relative to one another and relative to a specific reference point on the head-mounted display (HMD) 105. A locator 170, in some examples, may be a light emitting diode (LED), a corner cube reflector, a reflective marker, and/or a type of light source that contrasts with an environment in which the head-mounted display (HMD) 105 operates, or some combination thereof. Active locators 170 (e.g., an LED or other type of light emitting device) may emit light in the visible band (⁻380 nm to 850 nm), in the infrared (IR) band (⁻850 nm to 1 mm), in the ultraviolet band (10 nm to 380 nm), some other portion of the electromagnetic spectrum, or some combination thereof.

The one or more locators 170 may be located beneath an outer surface of the head-mounted display (HMD) 105, which may be transparent to wavelengths of light emitted or reflected by the locators 170 or may be thin enough not to substantially attenuate wavelengths of light emitted or reflected by the locators 170. Further, the outer surface or other portions of the head-mounted display (HMD) 105 may be opaque in the visible band of wavelengths of light. Thus, the one or more locators 170 may emit light in the IR band while under an outer surface of the head-mounted display (HMD) 105 that may be transparent in the IR band but opaque in the visible band.

The inertial measurement unit (IMU) 175 may be an electronic device that generates, among other things, fast calibration data based on or in response to measurement signals received from one or more of the head/body tracking sensors 180, which may generate one or more measurement signals in response to motion of head-mounted display (HMD) 105. Examples of the head/body tracking sensors 180 may include, but not limited to, accelerometers, gyroscopes, magnetometers, cameras, other sensors suitable for detecting motion, correcting error associated with the inertial measurement unit (IMU) 175, or some combination thereof. The head/body tracking sensors 180 may be located external to the inertial measurement unit (IMU) 175, internal to the inertial measurement unit (IMU) 175, or some combination thereof.

Based on or in response to the measurement signals from the head/body tracking sensors 180, the inertial measurement unit (IMU) 175 may generate fast calibration data indicating an estimated position of the head-mounted display (HMD) 105 relative to an initial position of the head-mounted display (HMD) 105. For example, the head/body tracking sensors 180 may include multiple accelerometers to measure translational motion (forward/back, up/down, left/right) and multiple gyroscopes to measure rotational motion (e.g., pitch, yaw, and roll). The inertial measurement unit (IMU) 175 may then, for example, rapidly sample the measurement signals and/or calculate the estimated position of the head-mounted display (HMD) 105 from the sampled data. For example, the inertial measurement unit (IMU) 175 may integrate measurement signals received from the accelerometers over time to estimate a velocity vector and integrates the velocity vector over time to determine an estimated position of a reference point on the head-mounted display (HMD) 105. It should be appreciated that the reference point may be a point that may be used to describe the position of the head-mounted display (HMD) 105. While the reference point may generally be defined as a point in space, in various examples or scenarios, a reference point as used herein may be defined as a point within the head-mounted display (HMD) 105 (e.g., a center of the inertial measurement unit (IMU) 175). Alternatively or additionally, the inertial measurement unit (IMU) 175 may provide the sampled measurement signals to the console 120, which may determine the fast calibration data or other similar or related data.

The inertial measurement unit (IMU) 175 may additionally receive one or more calibration parameters from the console 120. As described herein, the one or more calibration parameters may be used to maintain tracking of the head-mounted display (HMD) 105. Based on a received calibration parameter, the inertial measurement unit (IMU) 175 may adjust one or more of the IMU parameters (e.g., sample rate). In some examples, certain calibration parameters may cause the inertial measurement unit (IMU) 175 to update an initial position of the reference point to correspond to a next calibrated position of the reference point. Updating the initial position of the reference point as the next calibrated position of the reference point may help reduce accumulated error associated with determining the estimated position. The accumulated error, also referred to as drift error, may cause the estimated position of the reference point to “drift” away from the actual position of the reference point over time.

The scene rendering unit 185 may receive content for the virtual scene from a VR engine 145 and may provide the content for display on the electronic display 155. Additionally or alternatively, the scene rendering unit 185 may adjust the content based on information from the inertial measurement unit (IMU) 175, the vergence processing unit 830, and/or the head/body tracking sensors 180. The scene rendering unit 185 may determine a portion of the content to be displayed on the electronic display 155 based at least in part on one or more of the tracking unit 140, the head/body tracking sensors 180, and/or the inertial measurement unit (IMU) 175.

The imaging device 110 may generate slow calibration data in accordance with calibration parameters received from the console 120. Slow calibration data may include one or more images showing observed positions of the locators 125 that are detectable by imaging device 110. The imaging device 110 may include one or more cameras, one or more video cameras, other devices capable of capturing images including one or more locators 170, or some combination thereof. Additionally, the imaging device 110 may include one or more filters (e.g., for increasing signal to noise ratio). The imaging device 110 may be configured to detect light emitted or reflected from the one or more locators 170 in a field of view of the imaging device 110. In examples where the locators 170 include one or more passive elements (e.g., a retroreflector), the imaging device 110 may include a light source that illuminates some or all of the locators 170, which may retro-reflect the light towards the light source in the imaging device 110. Slow calibration data may be communicated from the imaging device 110 to the console 120, and the imaging device 110 may receive one or more calibration parameters from the console 120 to adjust one or more imaging parameters (e.g., focal length, focus, frame rate, ISO, sensor temperature, shutter speed, aperture, etc.).

The I/O interface 115 may be a device that allows a user to send action requests to the console 120. An action request may be a request to perform a particular action. For example, an action request may be to start or end an application or to perform a particular action within the application. The I/O interface 115 may include one or more input devices. Example input devices may include a keyboard, a mouse, a hand-held controller, a glove controller, and/or any other suitable device for receiving action requests and communicating the received action requests to the console 120. An action request received by the I/O interface 115 may be communicated to the console 120, which may perform an action corresponding to the action request. In some examples, the I/O interface 115 may provide haptic feedback to the user in accordance with instructions received from the console 120. For example, haptic feedback may be provided by the I/O interface 115 when an action request is received, or the console 120 may communicate instructions to the I/O interface 115 causing the I/O interface 115 to generate haptic feedback when the console 120 performs an action.

The console 120 may provide content to the head-mounted display (HMD) 105 for presentation to the user in accordance with information received from the imaging device 110, the head-mounted display (HMD) 105, or the I/O interface 115. The console 120 includes an application store 150, a tracking unit 140, and the VR engine 145. Some examples of the console 120 have different or additional units than those described in conjunction with FIG. 1. Similarly, the functions further described below may be distributed among components of the console 120 in a different manner than is described here.

The application store 150 may store one or more applications for execution by the console 120, as well as other various application-related data. An application, as used herein, may refer to a group of instructions, that when executed by a processor, generates content for presentation to the user. Content generated by an application may be in response to inputs received from the user via movement of the head-mounted display (HMD) 105 or the I/O interface 115. Examples of applications may include gaming applications, conferencing applications, video playback application, or other applications.

The tracking unit 140 may calibrate the system 100. This calibration may be achieved by using one or more calibration parameters and may adjust one or more calibration parameters to reduce error in determining position of the head-mounted display (HMD) 105. For example, the tracking unit 140 may adjust focus of the imaging device 110 to obtain a more accurate position for observed locators 170 on the head-mounted display (HMD) 105. Moreover, calibration performed by the tracking unit 140 may also account for information received from the inertial measurement unit (IMU) 175. Additionally, if tracking of the head-mounted display (HMD) 105 is lost (e.g., imaging device 110 loses line of sight of at least a threshold number of locators 170), the tracking unit 140 may re-calibrate some or all of the system 100 components.

Additionally, the tracking unit 140 may track the movement of the head-mounted display (HMD) 105 using slow calibration information from the imaging device 110 and may determine positions of a reference point on the head-mounted display (HMD) 105 using observed locators from the slow calibration information and a model of the head-mounted display (HMD) 105. The tracking unit 140 may also determine positions of the reference point on the head-mounted display (HMD) 105 using position information from the fast calibration information from the inertial measurement unit (IMU) 175 on the head-mounted display (HMD) 105. Additionally, the eye tracking unit 160 may use portions of the fast calibration information, the slow calibration information, or some combination thereof, to predict a future location of the head-mounted display (HMD) 105, which may be provided to the VR engine 145.

The VR engine 145 may execute applications within the system 100 and may receive position information, acceleration information, velocity information, predicted future positions, other information, or some combination thereof for the head-mounted display (HMD) 105 from the tracking unit 140 or other component. Based on or in response to the received information, the VR engine 145 may determine content to provide to the head-mounted display (HMD) 105 for presentation to the user. This content may include, but not limited to, a virtual scene, one or more virtual objects to overlay onto a real world scene, etc.

In some examples, the VR engine 145 may maintain focal capability information of the optics block 165. Focal capability information, as used herein, may refer to information that describes what focal distances are available to the optics block 165. Focal capability information may include, e.g., a range of focus the optics block 165 is able to accommodate (e.g., 0 to 4 diopters), a resolution of focus (e.g., 0.25 diopters), a number of focal planes, combinations of settings for switchable half wave plates (SHWPs) (e.g., active or non-active) that map to particular focal planes, combinations of settings for SHWPS and active liquid crystal lenses that map to particular focal planes, or some combination thereof.

The VR engine 145 may generate instructions for the optics block 165. These instructions may cause the optics block 165 to adjust its focal distance to a particular location. The VR engine 145 may generate the instructions based on focal capability information and, e.g., information from the vergence processing unit 190, the inertial measurement unit (IMU) 175, and/or the head/body tracking sensors 180. The VR engine 145 may use information from the vergence processing unit 190, the inertial measurement unit (IMU) 175, and the head/body tracking sensors 180, other source, or some combination thereof, to select an ideal focal plane to present content to the user. The VR engine 145 may then use the focal capability information to select a focal plane that is closest to the ideal focal plane. The VR engine 145 may use the focal information to determine settings for one or more SHWPs, one or more active liquid crystal lenses, or some combination thereof, within the optics block 176 that are associated with the selected focal plane. The VR engine 145 may generate instructions based on the determined settings, and may provide the instructions to the optics block 165.

The VR engine 145 may perform any number of actions within an application executing on the console 120 in response to an action request received from the I/O interface 115 and may provide feedback to the user that the action was performed. The provided feedback may be visual or audible feedback via the head-mounted display (HMD) 105 or haptic feedback via the I/O interface 115.

FIGS. 2A-2B illustrate various head-mounted displays (HMDs), in accordance with an example. FIG. 2A shows a head-mounted display (HMD) 105, in accordance with an example. The head-mounted display (HMD) 105 may include a front rigid body 205 and a band 210. The front rigid body 205 may include an electronic display (not shown), an inertial measurement unit (IMU) 175, one or more position sensors (e.g., head/body tracking sensors 180), and one or more locators 170, as described herein. In some examples, a user movement may be detected by use of the inertial measurement unit (IMU) 175, position sensors (e.g., head/body tracking sensors 180), and/or the one or more locators 170, and an image may be presented to a user through the electronic display based on or in response to detected user movement. In some examples, the head-mounted display (HMD) 105 may be used for presenting a virtual reality, an augmented reality, or a mixed reality environment.

At least one position sensor, such as the head/body tracking sensor 180 described with respect to FIG. 1, may generate one or more measurement signals in response to motion of the head-mounted display (HMD) 105. Examples of position sensors may include: one or more accelerometers, one or more gyroscopes, one or more magnetometers, another suitable type of sensor that detects motion, a type of sensor used for error correction of the inertial measurement unit (IMU) 175, or some combination thereof. The position sensors may be located external to the inertial measurement unit (IMU) 175, internal to the inertial measurement unit (IMU) 175, or some combination thereof. In FIG. 2A, the position sensors may be located within the inertial measurement unit (IMU) 175, and neither the inertial measurement unit (IMU) 175 nor the position sensors (e.g., head/body tracking sensors 180) may or may not necessarily be visible to the user.

Based on the one or more measurement signals from one or more position sensors, the inertial measurement unit (IMU) 175 may generate calibration data indicating an estimated position of the head-mounted display (HMD) 105 relative to an initial position of the head-mounted display (HMD) 105. In some examples, the inertial measurement unit (IMU) 175 may rapidly sample the measurement signals and calculates the estimated position of the HMD 105 from the sampled data. For example, the inertial measurement unit (IMU) 175 may integrate the measurement signals received from the one or more accelerometers (or other position sensors) overtime to estimate a velocity vector and integrates the velocity vector over time to determine an estimated position of a reference point on the head-mounted display (HMD) 105. Alternatively or additionally, the inertial measurement unit (IMU) 175 may provide the sampled measurement signals to a console (e.g., a computer), which may determine the calibration data. The reference point may be a point that may be used to describe the position of the head-mounted display (HMD) 105. While the reference point may generally be defined as a point in space; however, in practice, the reference point may be defined as a point within the head-mounted display (HMD) 105 (e.g., a center of the inertial measurement unit (IMU) 175).

One or more locators 170, or portions of locators 170, may be located on a front side 240A, a top side 240B, a bottom side 240C, a right side 240D, and a left side 240E of the front rigid body 205 in the example of FIG. 2. The one or more locators 170 may be located in fixed positions relative to one another and relative to a reference point 215. In FIG. 2, the reference point 215, for example, may be located at the center of the inertial measurement unit (IMU) 175. Each of the one or more locators 170 may emit light that is detectable by an imaging device (e.g., camera or an image sensor).

FIG. 2B illustrates a head-mounted displays (HMDs), in accordance with another example. As shown in FIG. 2B, the head-mounted display (HMD) 105 may take the form of a wearable, such as glasses. The head-mounted display (HMD) 105 of FIG. 2A may be another example of the head-mounted display (HMD) 105 of FIG. 1. The head-mounted display (HMD) 105 may be part of an artificial reality (AR) system, or may operate as a stand-alone, mobile artificial realty system configured to implement the techniques described herein.

In some examples, the head-mounted display (HMD) 105 may be glasses comprising a front frame including a bridge to allow the head-mounted display (HMD) 105 to rest on a user's nose and temples (or “arms”) that extend over the user's ears to secure the head-mounted display (HMD) 105 to the user. In addition, the head-mounted display (HMD) 105 of FIG. 2B may include one or more interior-facing electronic displays 203A and 203B (collectively, “electronic displays 203”) configured to present artificial reality content to a user and one or more varifocal optical systems 205A and 205B (collectively, “varifocal optical systems 205”) configured to manage light output by interior-facing electronic displays 203. In some examples, a known orientation and position of display 203 relative to the front frame of the head-mounted display (HMD) 105 may be used as a frame of reference, also referred to as a local origin, when tracking the position and orientation of the head-mounted display (HMD) 105 for rendering artificial reality (AR) content, for example, according to a current viewing perspective of the head-mounted display (HMD) 105 and the user.

As further shown in FIG. 2B, the head-mounted display (HMD) 105 may further include one or more motion sensors 206, one or more integrated image capture devices 138A and 138B (collectively, “image capture devices 138”), an internal control unit 210, which may include an internal power source and one or more printed-circuit boards having one or more processors, memory, and hardware to provide an operating environment for executing programmable operations to process sensed data and present artificial reality content on display 203. These components may be local or remote, or a combination thereof.

Although depicted as separate components in FIG. 1, it should be appreciated that the head-mounted display (HMD) 105, the imaging device 110, the I/O interface 115, and the console 120 may be integrated into a single device or wearable headset. For example, this single device or wearable headset (e.g., the head-mounted display (HMD) 105 of FIGS. 2A-2B) may include all the performance capabilities of the system 100 of FIG. 1 within a single, self-contained headset. Also, in some examples, tracking may be achieved using an “inside-out” approach, rather than an “outside-in” approach. In an “inside-out” approach, an external imaging device 110 or locators 170 may not be needed or provided to system 100. Moreover, although the head-mounted display (HMD) 105 is depicted and described as a “headset,” it should be appreciated that the head-mounted display (HMD) 105 may also be provided as eyewear or other wearable device (on a head or other body part), as shown in FIG. 2A. Other various examples may also be provided depending on use or application.

Compact Imaging Optics Using Liquid Crystal (LC) Layer

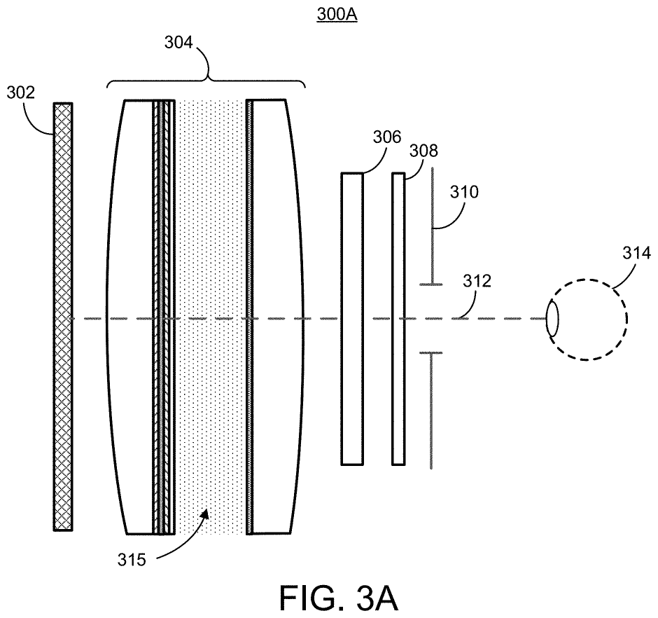

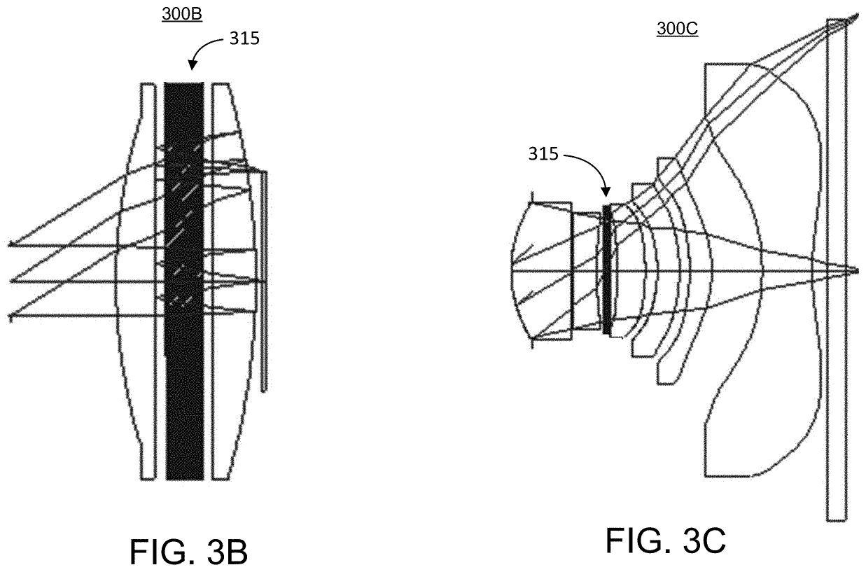

FIGS. 3A-3C illustrate schematic diagrams of various optical assemblies 300A-300C for dynamic glare reduction and/or sharpness enhancement, according to an example. FIG. 3A illustrates a view of an optical assembly 300A using at least one liquid crystal (LC) layer 315 to provide dynamic glare reduction and sharpness enhancement, according to an example. As shown, the optical assembly 300 may include a display 302, an optical stack 304, additional optical elements 306 and 308, and an aperture 310. Illumination 312 from the display 302 may traverse all these optical components in this optical assembly 300 to create one or more visual images at an eye 314 of a user.

The display 302 may be similar to the electronic display 155 described with respect to FIG. 1. The optical stack 304 may include any number of optical components. In some examples, the optical stack 304 may be similar to the optics block 165 described with respect to FIG. 1. In some examples, the optical stack 304 may include any number of pancake optics or optical stacks, as shown. At least one liquid crystal (LC) layer 315 may be provided in between two optical components of the optical stack 304, as shown.

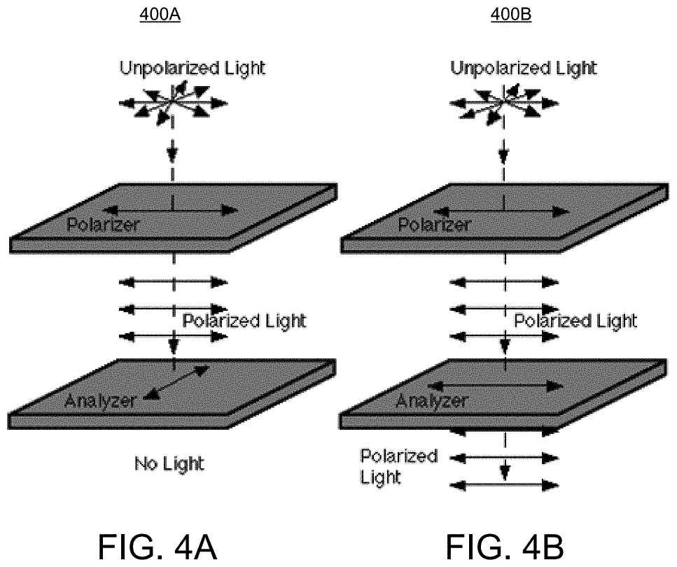

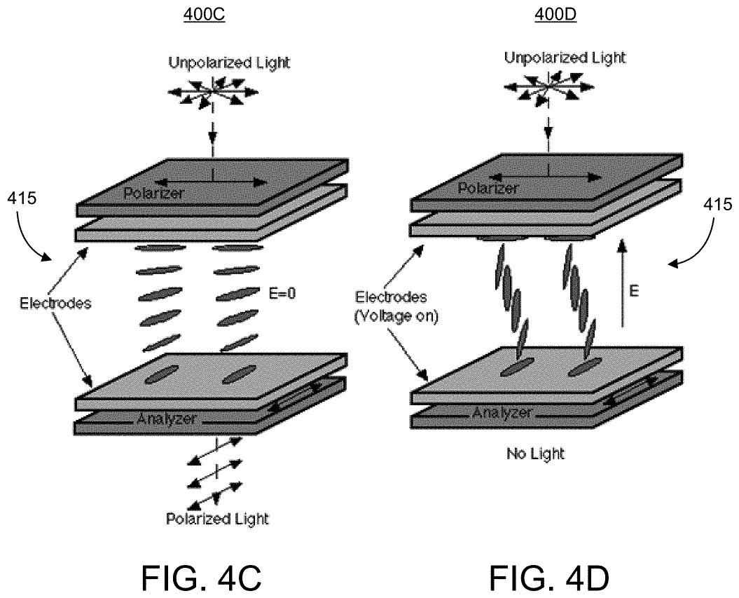

It should be appreciated that the liquid crystal (LC) layer 315 may include, but not limited to, a liquid crystal (LC) cell, such as a nematic liquid crystal (LC) cell, a nematic liquid crystal (LC) cell with chiral dopants, a chiral liquid crystal (LC) cell, a uniform lying helix (ULH) liquid crystal (LC) cell, a ferroelectric liquid crystal (LC) cell, or the like. In other examples, the liquid crystal (LC) cell may include an electrically drivable birefringence material or other similar material. Details of the liquid crystal (LC) layer 315 will be described in more detail with respect to FIGS. 4A-4D below.

The additional optical components 306 and 308 may include any number of type of optical component depending on various applications. In some examples, one of the additional optical components 306 and 308 may be a switchable optical element 306, which may be any number of switchable optical elements. For example, the switchable optical element 306 may include a switchable optical retarder, a switchable half wave plate, or other switchable optical element, which may be communicatively coupled to a controller (not shown). The controller may apply voltage to the switchable optical element 306 to configure the switchable optical element 306 to be in at least a first optical state or a second optical state.

One of the additional optical components 306 and 308 may also include an optical element 308, such as a Pancharatnam-Berry phase (PBP) lens (e.g., geometric phase lens (GPL)), a polarization sensitive hologram (PSH) lens, a polarization sensitive hologram (PSH) grating, a metamaterial (e.g., metasurface), a liquid crystal optical phase array, etc. The optical element 308 may also be communicatively coupled to a controller, which may apply voltage to the optical element 308. Although examples are directed to these specific additional optical elements 306 and 308, it should be appreciated that any, or none, of these or other types of optical elements may also apply. For example, the use of the liquid crystal (LC) layer 315 may obviate use of or need for these additional optical components 306 and 308, depending on desired application.

FIGS. 3B-3C illustrate additional views of optical assemblies 300B-300C using a liquid crystal (LC) layer 315 to provide dynamic glare reduction and/or sharpness enhancement, according to an example. As shown in FIG. 3B, an optical assembly 300B may be provided. The optical assembly 300B may be a simplified view of the optical assembly 300A of FIG. 3A. The optical assembly 300B may better illustrate placement of the liquid crystal (LC) layer 315 between two optical components. In some examples, liquid crystal (LC) material in the liquid crystal (LC) layer 315 may be controlled by applying (or not applying) voltage. It should also be appreciated that the liquid crystal (LC) layer 315 may be volumetrically controlled as well, as described in more detail below. The liquid crystal (LC) layer 315 may provide dynamic glare reduction and/or sharpness enhancement, as described herein. Providing the liquid crystal (LC) layer 315 between the two optical components 310 and 320 may provide these features without requiring any additional space.

For example, the optical assembly 300C may depict pancake optics, e.g., used in a head-mounted display (HMD), having a liquid crystal (LC) layer 315 to provide dynamic glare reduction and/or sharpness enhancement. Like FIG. 3B, the optical assembly 300C of FIG. 3C may include optical components, such as any number of optical lens components. As shown, a liquid crystal (LC) layer 315 may occupy space between two optical components of the pancake optics to provide dynamic glare reduction and/or sharpness enhancement. Although depicted between two specific optical components in FIG. 3C, it should be appreciated that the liquid crystal (LC) layer 315 may be used or provided between any other two optical components, and also in multiple spaces at any given time, depending on the specific need or application.

Liquid Crystal (LC) Layer as Polarizer

In some examples, the liquid crystal (LC) layer 315 may function as a polarizer, e.g., dynamic polarizer in an optical assembly. As mentioned above, a conventional polarizer is a dedicated optical component and when used in an optical stack, such a dedicated polarizer may therefore take up space or require additional steps to install, which is not ideal in compact imaging optics used in a head-mounted display (HMD) or camera device. Furthermore, a conventional polarizer can be fairly static. In other words, a dedicated polarizer may polarize all illumination that enters, and all of that illumination can only be polarized in one direction. Using the liquid crystal (LC) layer 315 rather than a conventional polarizer may provide more controllable dynamic polarization features since a liquid crystal (LC) layer 315 can be controlled via applied voltage. This not only minimizes of imaging optics (since the liquid crystal (LC) layer 315 may be provided between gaps in existing optical components), but also provides dynamic polarization control. In other words, the liquid crystal (LC) layer 315 may polarize some or all of the illumination (e.g., in zones) passing through it to reduce glare and/or increase sharpness. The liquid crystal (LC) layer 315 may also polarize light in different directions depending on optical assembly orientation.

Dynamic Glare Reduction and/or Enhanced Sharpness

When unpolarized light passes through a polarizing filter, only one plane of polarization is transmitted. Two polarizing filters used together transmit light differently depending on their relative orientation.

FIGS. 4A-4D illustrate a liquid crystal (LC) layer for providing dynamic glare reduction and/or sharpness enhancement in an optical assembly, according to an example. As shown in FIGS. 4A-4B, polarizing filters in an isotropic medium (such as air) is depicted. Herein, optical throughput may depend on a relative orientation of a polarizer and/or analyzer. For example, when the polarizers are arranged so that their planes of polarization are perpendicular to each other, light may be blocked, as shown in FIG. 4A. When the second filter (or analyzer) is parallel to the first, all of the light that passes by the first filter may also transmitted by the second, as shown in FIG. 4B, as polarized light.

As described above, a liquid crystal (LC) layer may provide a polarizing feature as well. To illustrate, a liquid crystal (LC) layer 415, such as a twisted nematic (TN) cell, may be used as a polarizer. Here, the liquid crystal (LC) layer 415 may be made up of two bounding plates (e.g., glass slides or windows), each with a transparent conductive coating (e.g., as indium tin oxide) that may also serve or act as an electrode. It should be appreciated that spacers (not shown) may also be provided to precisely control cell gap, two crossed polarizers (polarizer and analyzer), and/or the nematic liquid crystal material in between, as shown in FIGS. 4C-4D.

It should be noted that the polarizer and analyzer, depicted in FIGS. 4C-4D, may be arranged parallel to the director orientation at their adjacent glass plates, or oriented at 90 degrees to each other. The surfaces of the transparent electrodes in contact with the liquid crystals may be coated with a thin layer of polymer (not shown), which, for example, may be rubbed or brushed in one direction. The nematic liquid crystal molecules of the liquid crystal (LC) layer 415 may also tend to orient with their long axes parallel to this direction. The glass plates may be arranged so the molecules adjacent to the top electrode are oriented at a right angle to those at the bottom, as shown in FIG. 4C. Each polarizer may further be oriented with its easy axis parallel to the rubbing direction of the adjacent electrode (so the polarizer and analyzer are crossed).

In the absence of an electric field, the nematic director may undergo a smooth 90-degree twist within the cell (hence the name “twisted” nematic liquid crystal). Unpolarized light may enter the first polarizing filter and may emerge polarized in the same plane as the local orientation of the liquid crystal (LC) molecules. The twisted arrangement of the liquid crystal molecules within the cell may then acts as an optical wave guide (or polarizer) and rotate the plane of polarization by a quarter turn (90 degrees) so that the light, which may reach the second polarizer, can pass through it. In this state the liquid crystal (LC) cell may be “transparent,” allowing light to be transmitted.

When a voltage is applied to the electrodes, the liquid crystal molecules may align with the resulting electric field B, as shown in FIG. 4D, and the optical wave guiding (or polarization) property of the cell may be lost. The cell may now be “dark,” as it would be without the liquid crystal (LC) present, similar to that of FIG. 4A. When the electric field is turned off, the molecules relax back to their twisted state and the cell becomes transparent again.

Again, these descriptions are provided for illustrative purposes. In an optical assembly using a liquid crystal (LC) layer 315, as described herein, the liquid crystal (LC) layer 315 may provide polarizing functionality itself and therefore the polarizer and the analyzer shown in FIGS. 4C-4D may not be required. In other words, the liquid crystal layer (LC) may perform the polarizing functions and features in the optical assemblies 300A-300C without any additional components.

By providing a liquid crystal (LC) layer between any two optical components of an optical assembly, the liquid crystal (LC) layer may provide polarization without increasing the overall size or thickness of the optical assembly. Furthermore, the liquid crystal (LC) layer may also be configured and operated in various “zones” to provide dynamic polarization and/or sharpness enhancement.

Liquid Crystal (LC) Layer Operable in Dynamic Zones

For example, the systems and methods described herein may further allow customizable sub-regions, partitions, or “zones” within the liquid crystal (LC) layer. These zones within the liquid crystal (LC) layer may be separately controlled. In this way, not all of the liquid crystal (LC) layer may function as a polarizer at once, but perhaps only the edges to reduce glare in the periphery. It should also be appreciated that the systems and methods described herein may also include a sensor to help determine orientation of the optical assembly. For instance, the sensor may be any type of sensor (e.g., photo sensor, accelerometer, etc.) and may help determine which zones of the liquid crystal (LC) layer may need to applied voltage to function as a polarizer. In this way, polarization may be dynamic and may also polarize light in more than just one static direction. In this way, the systems and methods described herein may provide a dynamic solution to glare prevention and/or sharpness enhancement into an optical assembly. A user or wearer of a head-mounted display (HMD) using such an optical assembly, for example, may turn his or her gaze in any direction and any light or illumination that needs to be polarized may be polarized in an automatic and/or dynamic fashion without additional optical components and maintaining a relatively thin profile. In other words, an array of liquid crystal display (LCD) cells, for example, may be controlled remotely or locally. Therefore, any particular “zone” (or region of interest) may be configured to have a sharp image with no visual noise due to the nature of polarization provided. In a same or similar way, glare, like noise, from any sub-region may also be minimized by opposite polarization control.

Liquid Crystal (LC) Layer as Optical Lens

Not only do the systems and methods provide dynamic glare reduction and/or sharpness enhancement using compact imaging optics with a liquid crystal (LC) layer functioning as a polarizer, a liquid crystal (LC) layer between an existing gap in pancake optics may also provide multiple functions. For examples, the liquid crystal (LC) layer may function to serve as one or more optical components within an optical stack. For example, for curved optical components or windows in pancake optics, the liquid crystal (LC) layer, which may be placed within these non-flat components, may also take on a “curved” shape. The resulting contours may cause the liquid crystal (LC) layer to function similarly like an optical lens or other similar optics. In this way, use of liquid crystal (LC) layers may minimize need for additional optics or reduce current optical components in existing pancake optics. It should be appreciated that since optical path is generally dependent on refractive index of medium, use of liquid crystal (LC) layers may help to shorten optical stack height or thickness because the liquid crystal (LC) layer may have higher index of refraction relative to air. Furthermore, if a liquid crystal (LC) layer medium has a certain curvature (e.g., created by plastic or glass cover window), it may then function appropriately as a lens element with a certain refractive index.

In addition, customizable volumetric control of the liquid crystal (LC) layer may provide thermal compensation or other similar effects. In other words, by providing a liquid crystal (LC) layer that is customizable in size, thickness, etc., the systems and methods described herein may provide a flexible and low-cost way to improve visual acuity without increasing size, thickness, or overall bulkiness of the optical assembly.

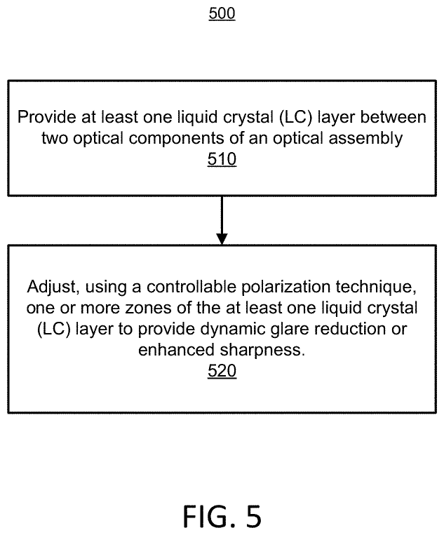

FIG. 5 illustrates a flow chart of a method 500 for adjusting optical power using an alternative medium, according to an example. The method 500 is provided by way of example, as there may be a variety of ways to carry out the method described herein. Although the method 500 is primarily described as being performed by the system 100 of FIG. 1 and/or optical lens assemblies 300A-300C of FIGS. 3A-4C, the method 500 may be executed or otherwise performed by one or more processing components of another system or a combination of systems. Each block shown in FIG. 5 may further represent one or more processes, methods, or subroutines, and one or more of the blocks may include machine readable instructions stored on a non-transitory computer readable medium and executed by a processor or other type of processing circuit to perform one or more operations described herein.

At block 510, at least one liquid crystal (LC) layer may be provided between two optical components of an optical assembly. As described herein, the at least one liquid crystal (LC) layer may be a liquid crystal (LC) cell comprising at least one a nematic liquid crystal (LC) cell, a nematic liquid crystal (LC) cell with chiral dopants, a chiral liquid crystal (LC) cell, a uniform lying helix (ULH) liquid crystal (LC) cell, a ferroelectric liquid crystal (LC) cell, or electrically drivable birefringence material.

At block 520, the liquid crystal (LC) layer may be adjusted. By adjusting applied voltage, one or more zones of the at least liquid crystal (LC) layer may be adjusted to provide dynamic glare reduction or enhanced sharpness. In some examples, this may be achieved using a controllable polarization technique. In some examples, the controllable polarization technique may include determining optical assembly orientation using a sensor, as described above. Also, the controllable polarization technique may dynamically adjust polarization of the at least one liquid crystal (LC) layer based on the determined optical assembly orientation. In some examples, each of the one or more of zones is controlled and adjusted separately from each other.

Additionally, in some examples, the optical assembly may include a cover window for the at least one liquid crystal (LC) layer. The cover window may have similar contours to that of the optical components in which the liquid crystal (LC) layer is placed. In some examples, the cover window may be curved, thus causing the at least one liquid crystal (LC) layer to function as an optical lens as opposed or in additional to polarization.

It should be appreciated that the type of liquid crystal (LC) layer may be configured and/or the chamber thickness adjusted based at least in part on user preference, environmental conditions, or other parameter. In some examples, this may be achieved manually or automatically by a head-mounted display (HMD). For example, the head-mounted display (HMD) may include opto-electronic components that are capable to automatically detecting a users preferences, detect environmental conditions (e.g., using one or more sensors), and automatically adjusting the liquid crystal (LC) layer in full or in part (e.g., zones). In this way, the head-mounted display (HMD) may automatically provide polarization, glare reduction, and/or image sharpness enhancement without substantially increasing thickness of the overall optical assembly, adding additional optical components, or otherwise.

### Additional Information

The systems and methods described herein may provide a technique for reducing glare and enhancing sharpness using a liquid crystal (LC) layer in an optical assembly, which, for example, may be used in a head-mounted display (HMD) or other optical applications.

The benefits and advantages of the optical lens configurations described herein, may include, among other things, optical power customizability while minimizing overall lens assembly thickness, reducing power consumption, increasing product flexibility and efficiency, and improved resolution. This may be achieved in any number of environments, such as in virtual reality (VR), augmented reality (AR), and/or mixed reality (MR) environments, or other optical scenarios.

As mentioned above, there may be numerous ways to configure, provide, manufacture, or position the various optical, electrical, and/or mechanical components or elements of the examples described above. While examples described herein are directed to certain configurations as shown, it should be appreciated that any of the components described or mentioned herein may be altered, changed, replaced, or modified, in size, shape, and numbers, or material, depending on application or use case, and adjusted for desired resolution or optimal results. In this way, other electrical, thermal, mechanical and/or design advantages may also be obtained.

It should be appreciated that the apparatuses, systems, and methods described herein may facilitate more desirable headsets or visual results. It should also be appreciated that the apparatuses, systems, and methods, as described herein, may also include or communicate with other components not shown. For example, these may include external processors, counters, analyzers, computing devices, and other measuring devices or systems. In some examples, this may also include middleware (not shown) as well. Middleware may include software hosted by one or more servers or devices. Furthermore, it should be appreciated that some of the middleware or servers may or may not be needed to achieve functionality. Other types of servers, middleware, systems, platforms, and applications not shown may also be provided at the back-end to facilitate the features and functionalities of the headset.

Moreover, single components described herein may be provided as multiple components, and vice versa, to perform the functions and features described above. It should be appreciated that the components of the apparatus or system described herein may operate in partial or full capacity, or it may be removed entirely. It should also be appreciated that analytics and processing techniques described herein with respect to the liquid crystal (LC) or optical configurations, for example, may also be performed partially or in full by these or other various components of the overall system or apparatus.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and/or interfaces, may be any number of optical, mechanical, electrical, hardware, network, or software components, circuits, elements, and interfaces that serves to facilitate communication, exchange, and analysis data between any number of or combination of equipment, protocol layers, or applications. For example, some of the components described herein may each include a network or communication interface to communicate with other servers, devices, components or network elements via a network or other communication protocol.

Although examples are generally directed to head-mounted displays (HMDs), it should be appreciated that the apparatuses, systems, and methods described herein may also be used in other various systems and other implementations. For example, these may include other various head-mounted systems, eyewear, wearable devices, optical systems, etc. in any number of virtual reality (VR), augmented reality (AR), and/or mixed reality (MR) environments, or beyond. In fact, there may be numerous applications in various optical or data communication scenarios, such as optical networking, image processing, etc.

It should be appreciated that the apparatuses, systems, and methods described herein may also be used to help provide, directly or indirectly, measurements for distance, angle, rotation, speed, position, wavelength, transmissivity, and/or other related optical measurements. For example, the systems and methods described herein may allow for a higher optical resolution and increased system functionality using an efficient and cost-effective design concept. With additional advantages that include higher resolution, lower number of optical elements, more efficient processing techniques, cost-effective configurations, and smaller or more compact form factor, the apparatuses, systems, and methods described herein may be beneficial in many original equipment manufacturer (OEM) applications, where they may be readily integrated into various and existing equipment, systems, instruments, or other systems and methods. The apparatuses, systems, and methods described herein may provide mechanical simplicity and adaptability to small or large headsets. Ultimately, the apparatuses, systems, and methods described herein may increase resolution, minimize adverse effects of traditional systems, and improve visual efficiencies.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. An optical assembly, comprising:
an optical stack comprising at least two optical elements; and
at least one liquid crystal (LC) layer between the at least two optical elements, wherein the liquid crystal (LC) layer provides dynamic glare reduction and enhanced sharpness using a controllable polarization technique.

2. The optical assembly of claim 1, wherein the optical stack comprises pancake optics.

3. The optical assembly of claim 1, wherein the at least one liquid crystal (LC) layer is a liquid crystal (LC) cell comprising at least one a nematic liquid crystal (LC) cell, a nematic liquid crystal (LC) cell with chiral dopants, a chiral liquid crystal (LC) cell, a uniform lying helix (ULH) liquid crystal (LC) cell, a ferroelectric liquid crystal (LC) cell, or electrically drivable birefringence material.

4. The optical assembly of claim 1, wherein the controllable polarization technique comprises:
determining optical assembly orientation using a sensor; and
dynamically adjusting polarization of the at least one liquid crystal (LC) layer based on the determined optical assembly orientation.

5. The optical assembly of claim 1, wherein the controllable polarization technique is based on at least user input.

6. The optical assembly of claim 1, wherein the at least one at least one liquid crystal (LC) comprises a plurality of zones so that polarization in each of the plurality of zones is controlled and adjusted separately from each other.

7. The optical assembly of claim 1, further comprising:
a cover window for the at least one liquid crystal (LC) layer.

8. The optical assembly of claim 7, wherein the cover window is curved causing the at least one liquid crystal (LC) layer to function as an optical lens.

9. The optical assembly of claim 1, wherein the optical assembly is part of a head-mounted display (HMD) used in at least one of a virtual reality (VR), augmented reality (AR), or mixed reality (MR) environment.

10. A head-mounted display (HMD), comprising:
a display element to provide display light; and
an optical assembly to provide display light to a user of the head-mounted display (HMD), the optical assembly comprising:
an optical stack comprising at least two optical elements; and
at least one liquid crystal (LC) layer between the at least two optical elements, wherein the liquid crystal (LC) layer provides dynamic glare reduction and enhanced sharpness using a controllable polarization technique.

11. The head-mounted display (HMD) of claim 10, wherein the optical stack comprises pancake optics.

12. The head-mounted display (HMD) of claim 10, wherein the at least one liquid crystal (LC) layer is a liquid crystal (LC) cell comprising at least one a nematic liquid crystal (LC) cell, a nematic liquid crystal (LC) cell with chiral dopants, a chiral liquid crystal (LC) cell, a uniform lying helix (ULH) liquid crystal (LC) cell, a ferroelectric liquid crystal (LC) cell, or electrically drivable birefringence material.

13. The head-mounted display (HMD) of claim 10, wherein the controllable polarization technique comprises:
determining optical assembly orientation using a sensor; and
dynamically adjusting polarization of the at least one liquid crystal (LC) layer based on the determined optical assembly orientation.

14. The head-mounted display (HMD) of claim 10, wherein the controllable polarization technique is based on at least user input.

15. The head-mounted display (HMD) of claim 10, wherein the at least one at least one liquid crystal (LC) comprises a plurality of zones so that polarization in each of the plurality of zones is controlled and adjusted separately from each other.

16. The head-mounted display (HMD) of claim 10, further comprising:
a cover window for the at least one liquid crystal (LC) layer.

17. The head-mounted display (HMD) of claim 10, wherein the cover window is curved causing the at least one liquid crystal (LC) layer to function as an optical lens.

18. A method for providing dynamic polarization in an optical assembly, comprising:
providing at least one liquid crystal (LC) layer between two optical components of an optical assembly; and
adjusting, using a controllable polarization technique, one or more zones of the at least liquid crystal (LC) layer to provide dynamic glare reduction or enhanced sharpness.

19. The method of claim 18, wherein the at least one liquid crystal (LC) layer is a liquid crystal (LC) cell comprising at least one a nematic liquid crystal (LC) cell, a nematic liquid crystal (LC) cell with chiral dopants, a chiral liquid crystal (LC) cell, a uniform lying helix (ULH) liquid crystal (LC) cell, a ferroelectric liquid crystal (LC) cell, or electrically drivable birefringence material.

20. The method of claim 18, wherein the controllable polarization technique comprises:
determining optical assembly orientation using a sensor; and
dynamically adjusting polarization of the at least one liquid crystal (LC) layer based on the determined optical assembly orientation,
wherein each of the one or more of zones is controlled and adjusted separately from each other, and wherein the at least one liquid crystal (LC) layer is configured to operate as a polarizer or an optical lens.
